(19) United States
(12) Patent Application Publication
(10) Pub. No.: US 2009/0091097 A1
(43) Pub. Date: Apr. 9, 2009

(54) COLLAPSIBLE SLED WITH SPRING SUSPENSION

(76) Inventors: Hans Deiseroth, Frankfurt am Main (DE); Thomas Breen, Frankfurt am Main (DE)

Correspondence Address: MICHAEL J. STRIKER, 103 EAST NECK ROAD, HUNTINGTON, NY, 11743, US

(21) Appl. No.: 11/571,902

(22) PCT Filed: Sep. 24, 2004
(86) PCT No.: PCT/DE2004/002142

§ 371 Date: Nov. 13, 2008

(30) Foreign Application Priority Data
Jul. 13, 2004 (DE) 20 2004 011 094.6

(51) Int. Cl. B62B 13/16

(52) U.S. Cl. 280/20

(57) ABSTRACT

The invention concerns the fields of vehicle engineering and sporting goods. It relates to a sled, preferably with two parallel interspaced runners, with spring suspension. The seat frame (5) and the runner frame (2, 3, 11 to 14) can be collapsed in a vertical direction when the sled is not in use. The seat frame (5), together with the sitting surface (18), is mounted in a rotational and detachable manner, via both of its front ends (6, 7), on the front traverse (4) of the runner frame by means of two half-shells provided with quick-release latches (8). The runners (2, 3) are, approximately at mid-length, joined in a fixed manner to the seat frame and to the sitting surface by two upward sloping rods or tubes (10, 11) and (12, 13) and by a transverse member (14), to which the longitudinal bars are fastened in a fixed manner, said rods or tubes being fastened to the runners in a fixed manner The traverse (4) forms, together with the runners and with the rods or tubes, the whole of the runner frame. The seat frame (5) has, in its front longitudinal section, a traverse (9). A suspension strut (15) is mounted between the traverse and the transversal member (14) while being able to turn relative thereto.

The present invention relates to a sled, preferably having two parallel, interspaced runners with spring suspension, and which is collapsible when not in use, in order to transport or store it.

Sleds having different embodiments have been known for a long time. The most widespread types of sleds are those composed of two parallel, interspaced, vertically situated lateral parts or frames. The lateral part includes, on the underside, the runner which extends horizontally in the longitudinal direction, the front part of which curves upward and is connected at the end to the top, horizontally extending frame part. The upper frame part and the lower frame part are rigidly connected to one another by one or more vertical pillars. The two lateral parts are rigidly connected to one another via several traverses which are located between the upper longitudinal pillars and/or the vertical pillars of each lateral part. The sitting surface composed of rigid or flexible material is mounted on the upper longitudinal parts of the lateral parts. These common sleds are very stable per se. In particular, the runners are guided in a reliable manner regardless of the surface on which they run (snow, ice, different types of runs), and the two runners are prevented from following separate, deviating paths. These common sleds have the considerable disadvantage, however, that, due to the rigid connection of the components and, in particular, the runners, and the sitting surface, all impacts resulting from the varied terrain of the sled run are transmitted in an undamped manner to the sitting surface and, therefore, the rider. Although the impacts may be damped by using flexible sitting surfaces such as a textile fabric, the riding comfort is very limited. These common sleds have the disadvantage that, due to their rigid design, when they travel across uneven—rolling, in particular—terrain, e.g., when they travel across several bumps in brief succession, the sled becomes unstable and departs from the desired direction of travel or may even begin to jump and lift off of the sled run. A further disadvantage of this common sled is that it requires a relatively large amount of space when transported and/or stored, because its height is unchangeable.

To prevent these disadvantages, several sleds have been developed, in which the upper part of the sled and the sitting surface are connected via spring action, and/or in which the space required by the sled for transport or storage is reduced by enabling the the lateral parts of the sled with the runners to be folded into one another and by collapsing the sitting surface, or by enabling the upper sled part with the sitting surface to be lowered in the direction of the runner part. DE 196 13 478 A1 describes a sled of this type with spring action, in which the seat is connected to the two runners via two front and two rear pendulum supports which are detachably braced via springs and cords. The pendulum supports are rotatably situated in the region of the seat, one ahead of and one behind a traverse, in the longitudinal direction. The pendulum supports are attached to the runners via elastic elements. According to the present invention, the sitting surface and the rider are therefore provided with shock absorption against impacts that are transferred from the sled run via the runners. In addition, after the bracing of the pendulum supports is decoupled, the seat may be collapsed onto the runners, thereby also reducing the amount of space required by the sled when not in use. This design has considerable disadvantages in terms of the stability of the device, however, and primarily in terms of the directional stability and riding safety. Even if the pendulum supports have dimensionally stable guidance on the traverses in the region of the seat, an extremely unstable connection to the individual components of the sled is attained via the connection of the traverses with the runners using elastic elements, preferably rubber elements, and the bracing using only coil springs and a cord, which results in separate motions taking place in all regions of the sled, up to and including simultaneous motions of the seat and the runners in all directions and, especially, in opposite directions. Although the object of DE 196 13 478 A1 is to provide a steerable sled, the design proposed above results in a lack of steerability.

DE-PS 359 247 describes a further sled, in which the two runners are connected in a collapsible manner in their front upwardly sloping region, and the seat is stretched between the hinge connection and two expansion braces in the rear region of the sled using cords and springs inserted therein. The expansion braces are connected to the runners using ball joints, and they are hingedly connected to one another. This sled is an improvement over the common sled described initially in terms of fewer impacts being transferred to the body of the rider, and in terms of the amount of space required for transport and storage, because the two lateral parts with runners and the seat stretched between them are collapsible in the vertical direction. The design selected therefor results in the same disadvantages associated with the sled described above and in DE 196 13 478 A1. The instability of the sled itself and with regard for the driving behavior is increased further via the absence of stabilizers for the two runner parts, and due to the absence of safeguards against the two runners making undesired folding motions via their hinged connection and the joint of the expansion braces during sledding. In addition, the directional stability of the sled is made worse by the fact that the runners come together at the front end of the sled, at the hinge joint located in the central axis, in the longitudinal direction.

Finally, a single-runner sled with two auxiliary runners is described in DE-PS 345 928, in the case of which the seat which is mounted on the two main central runners is held by several articulated supports which are installed on the runner and on the seat in a manner such that they are rotatable in the longitudinal direction. The articulated supports are provided with shock absorption toward the front and back in the longitudinal direction via coil springs which are installed on the top side of the main central runner. The object of this design, however, is to create a rocking seat for a sled, which may be rocked back and forth in the longitudinal direction by the user during sledding. Via the combination of articulated supports with two coil springs, the transfer of impacts from the sled run via the runner to the rider is eliminated to a limited extent. However, the disadvantage—which still exists—that a single-runner sled is more difficult to operate than a two-runner sled is made even worse by the fact that the runners and the seat may move in opposite longitudinal directions, even though this is desired. The main risk is that, without inherent stabilization, the sled may start to make a rolling motion and become uncontrollable when traveling down a bumpy sled run.

The object of the present invention, therefore, is to improve the known sled in a manner such that the disadvantages described are prevented and a sled is created that combines high stability of the sled body itself and reliable driving behavior with protection of the rider against impacts on his body. In addition, the amount of space required by the sled for transport and storage will be reduced as compared with its state during use, using a minimal amount of effort.

This object is attained essentially via the design of sled as described in the characterizing part of claim 1. Expedient embodiments are the subject of the dependent claims.

A preferred embodiment of the sled is explained below with reference to drawings.

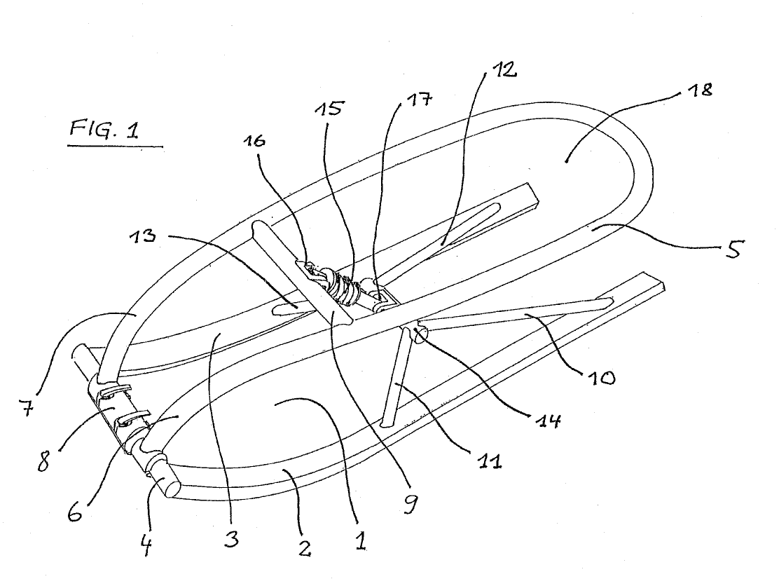

FIG. 1 shows the sled in a front side view;

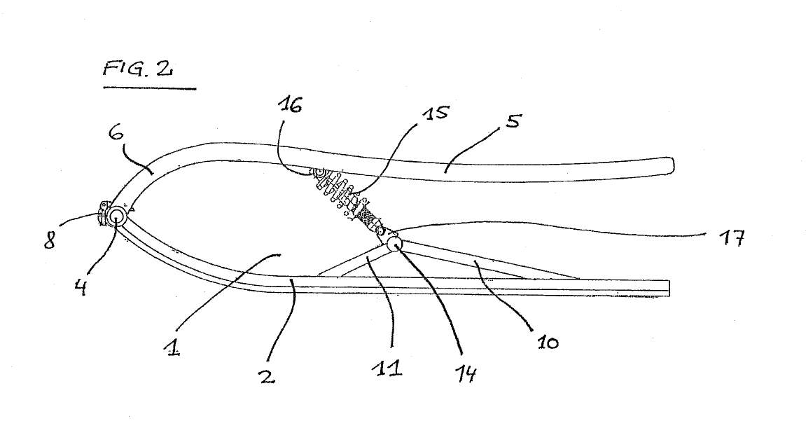

FIG. 2 shows the sled in FIG. 1, in a side view;

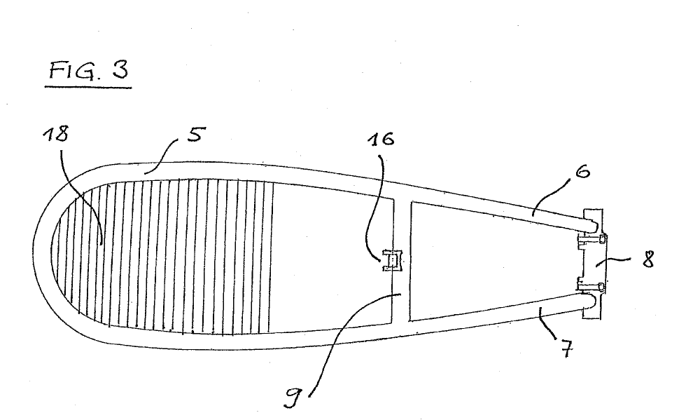

FIG. 3 shows the seat frame of the sled in FIG. 1, in a view from above;

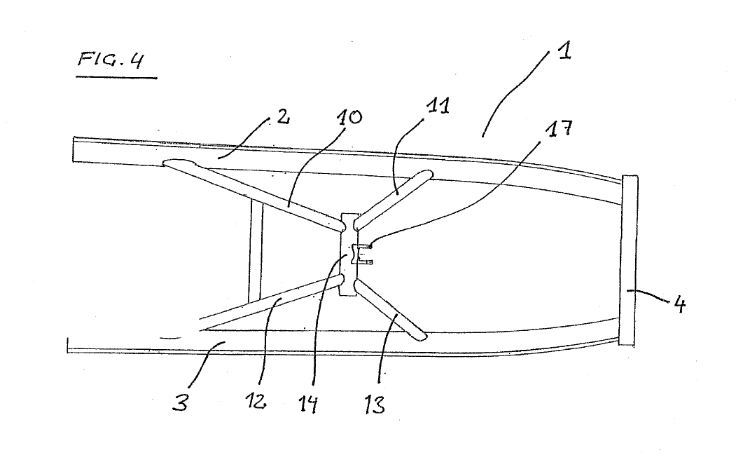

FIG. 4 shows the runner frame of the sled in FIG. 1 with the two runners and the connection and support element, in a top view;

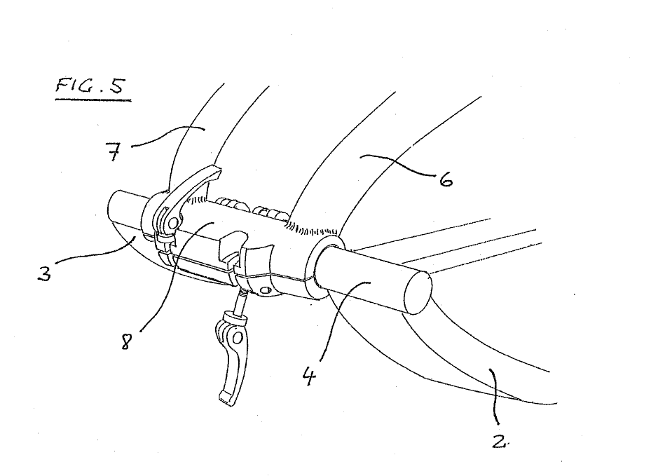

FIG. 5 shows, as a detail of FIG. 1, the detachable linkage of the sled with the quick-release latch installed on the runner frame, in the operational state of the sled;

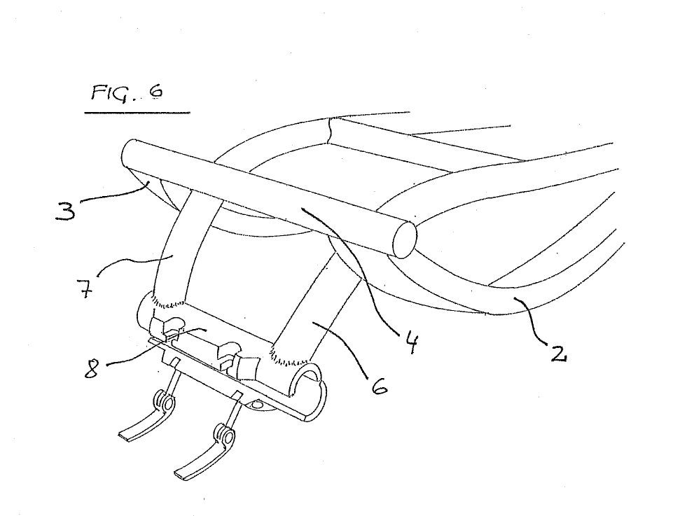

FIG. 6 shows the sled in FIG. 1 with the quick-release latch opened and the seat frame folded down, so that the sled may be transported or stored.

The sled according to the present invention is composed of the runner frame (1) with two parallel, interspaced runners (2) and (3) which curve upward in the longitudinal direction in the front region and are rigidly connected at their front ends to the traverse (4) which has a circular cross section. The sled according to the present invention is also composed of the seat frame (5) which is rigidly connected—via its two front ends (6) and (7) which point toward the tip of the sled—to the quick-release latch (8) which extends transversely to the ends in a plane with the seat frame. The seat frame (5) is mounted via the quick-release latch (8) on the traverse (4) and, therefore, the runner frame (1) in a horizontally rotatable, detachable manner. The quick-release latch (8) is composed of two half-shells which, in the embodiment shown, are connected at one of their longitudinal sides via hinges such that they may be swung open. On their longitudinal sides opposite to the hinges, the half-shells include at least one and preferably two clamping closures, as shown in FIGS. 5 and 6, or clasp closures. To prevent wear from occurring due to the rotational motions of the seat frame (5) with the quick-release latch (8), a bushing composed of plastic or another material is installed on the traverse (4). This bushing is not indispensible for the function—according to the present invention—of the sled, however. Via the half-shells, the quick-release latch (8) encloses the traverse (4) and the bushing of the runner frame (1). The diameter of the cross section of the half-shells, i.e., the inner diameter of the quick-release latch in the closed state, slightly exceeds the outer diameter of the traverse (4) in a manner such that the seat frame is dimensionally stable but rotates easily about the traverse (4) as the axis.

The half-shells of the quick-release latch (8) may also be connected in a manner other than that shown in the drawings. For instance, the half-shells may include—on their longitudinal sides opposite the hinges—extensions with corresponding boreholes for closure using screws or via another method. Likewise, in the context of the present invention, the seat frame (5) may be installed on the traverse (4) in a rotationally moveable and detachable manner using other means. It is within the scope of the present invention for the seat frame (5) to be attached to the traverse (4) in a rotatable but non-detachable manner using a tubular traverse instead of using the quick-release latch (8).

Likewise, instead of providing the traverse (4) on the front ends of the two runners (2) and (3), a tubular section situated transversely to each runner may be rigidly connected to a free section between them. In this case, the seat frame (5) includes a tubular traverse instead of a quick-release latch (8) on its ends (6) and (7), the inner diameter of the tubular section corresponding to the inner diameter of the tubular sections on the runners (2) and (3). The length of this traverse is equal to the open distance between the two tubular sections, thereby enabling the seat frame to be inserted into the open space using this traverse. The runner frame (1) and the seat frame (5) are then rotatably connected via an axle which is detachably inserted through the tubular sections of the runners (2) and (3) and the traverse of the seat frame (5). In this embodiment, the stability of the runner frame (1) may be reduced, however, due to the absence of the rigid connection of the two runners (2) and (3) at their front ends as compared with the embodiment having the traverse (4) described above.

The seat frame (5) which is advantageously formed out of a single-pieced profile preferably includes a traverse (9) located in the front half of its entire length, but at a distance from the tip of the sled and ends (6) and (7) of the seat frame. The runner frame (1) has, as shown in FIGS. 1, 2 and 4, a bracing for both runners (2) and (3), which is composed of two longitudinal braces (10), (11), and (12), (13) which are undetachably fastened to the runners (2) and (3). The braces (10), (11) and braces (12), (13) extend diagonally upward into the imagined interior of the sled and meet at approximately mid-length of the runners at a horizontally situated transversal member (14), to which they are rigidity attached on opposite sides.

A suspension strut (15) composed of a coil spring or a pneumatic spring and a telescoping shock absorber located therein is located between the traverse (9) of the seat frame (5) and the transversal member (14) of the runner frame (1). This suspension strut (15) is attached in a rotatable, detachable manner via its top end to the traverse (9) and via its lower end to the transveral member (14) via extension pieces (16) and (17) having transverse axes.

A sitting surface (18) composed of rigid or flexible material is mounted on or in the seat frame (5) in a manner known per se.

In the embodiment of the sled described, the seat frame (5) with the sitting surface (18) is supported on the runner frame (1) only via the suspension strut (15), and it is rotatably supported on the traverse (4). Impacts that originate from the sled run and act on the runners (2) and (3) are absorbed and damped by the suspension strut (15). As a result, the energy of impact does not act on the sitting surface (18) and the body of the rider, or it is greatly reduced. Different spring and damping values may be selected for the suspension struts (15) depending on the conditions under which the sled will be used. Advantageously, suspension struts having adjustable spring and damping values may be used instead. The runner frame (1), runners (2) and (3), and seat frame (5) may be composed of metal, or preferably of aluminum, plastic, wood, or combinations of these materials.

To reduce the amount of space required to transport or store the sled, after the quick-release latch (8) is opened, the seat frame (5) is removed from the traverse (4) by first swiveling the seat frame rearward via the rotatable linkage on the suspension strut (15), so that it may then be swiveled in the longitudinal direction toward the front underneath the traverse (4) or over it.

Compared with the common, rigid design mentioned initially, the sled according to the present invention has the advantage that, when it travels across rolling or bumpy terrain, impacts are largely prevented from being transferred to the sitting surface and the body of the rider, or they are at least decisively reduced. Using the sled according to the present invention, the advantage is also attained that the space required to transport and store the sled is reduced to a considerable extent via the described solution of connecting the seat frame (5) to the traverse (4) of the runner frame (1) and via the lowered placement of the seat frame. Compared with the known sleds having spring suspension, and, in particular, sleds that are also collapsible or foldable, the considerable instability of the device itself, and its inadequate directional stability are prevented using the sled according to the present invention. At the same time, due to the use of a suspension strut (1 5) as the connection between the seat frame and the runner frame (1), the runners are better able to adapt to the shape of the terrain, thereby also improving the directional stability and reducing the energy of impact, even in the region of the runner frame.

What is claimed is:

1. A sled composed of a runner frame (1) and preferably two parallel, interspaced runners (2) and (3) which are bent upward in the longitudinal direction in the front region, and which are rigidly connected via their front ends to a traverse (4); the sled is also composed of a seat frame (5) with a sitting surface (18) having a resilient connection to the runner frame (1) and the seat frame (5),
wherein
the seat frame (5) includes, at its two front ends (6) and (7) which point toward the tip of the sled, a traverse as a quick-release latch (8) composed of two open and closeable half-shells which enclose the traverse (4) in a horizontally rotatable and detachable manner, and wherein the runner frame (1) includes a bracing at approximately mid-length of the two runners (2) and (3), which is composed of two longitudinal rods (10), (11), and (12), (13) which are fastened to the runners (2) and (3) in a fixed manner, and which slope upward into the interior of the sled body and terminate at a horizontally situated transversal member (14), to which they are rigidly connected on opposite sides, while the seat frame (5) includes a traverse (9) located in the front longitudinal section but at a distance from the tip of the sled, and wherein a suspension strut (15) is located between the traverse (9) and the transversal member (14), the suspension strut (15) being attached to the transversal member (14) in a rotatable manner via extensions (16) with transverse axes.

2. The sled as recited in claim 1,
wherein
the half-shells of the quick-release latch (8) include one or more hinges on the outside of their longitudinal sides, and, on their opposite longitudinal sides, a clamping closure or several clamping closures, or a clasp closure or several clasp closures.

3. The sled as recited in claim 1,
wherein
the quick-release latch (8) includes detachable threaded connections instead of the clamping closures on the half-shells on the longitudinal side opposite the hinges, or the half-shells are fixedly, detachably connected in another known manner.

4. The sled as recited in claim 1,
wherein
the seat frame (5) is rotatably and non-detachably attached to the traverse (4) via a tubular traverse at ends (6) and (7).

5. The sled as recited in claim 1,
wherein,
instead of the traverse (4), a tube section situated transversely to each runner is rigidly connected to the front ends of runners (2) and (3) with an open section between them, and the seat frame (5) includes a tubular traverse at its ends (6) and (7), the inner diameter of which corresponds to that of tube sections (2) and (3), and the length of which corresponds to the open distance between the two tube sections; an axle is detachably inserted through the tube sections of the runners (2) and (3) and the traverse of the seat frame (5) in order to connect the runner frame (1) and the seat frame (5).

6. The sled as recited in claim 1,
wherein
the suspension strut (15) is composed of a coil spring or a pneumatic spring and a telescoping shock absorber which is located therein or is combined therewith in another manner.

7. The sled as recited in claim 1,
wherein,
after the quick-release latch (8) is opened, or after the axle is removed, the seat frame (5) is swiveled toward the rear via the rotatable linkage on the suspension strut (1 5), and is then guided under the traverse (4) of the runner frame (1), or it is swiveled past the traverse (4), toward the front.

8. The sled as recited in claim 1,
wherein
a bushing made of plastic or another material is installed on the traverse (4).

9. The sled as recited in claim 5,
wherein
bushings made of plastic or another material are present on the axle to be inserted, or on the inner sides of the tube sections.

10. The sled as recited in claim 1,
wherein
the sitting surface (18) is mounted on the seat frame (5) in a manner known per se, and it is composed of a rigid or flexible material (wood, plastic, leather, cloth, etc.).
